(19) United States
(12) Patent Application Publication
(10) Pub. No.: US 2014/0314361 A1
(43) Pub. Date: Oct. 23, 2014

(54) COMPACT PRELOAD INTEGRATED MECHANISM FOR BEARINGS

(71) Applicant: William MORATZ, Gardiner, NY (US)

(72) Inventor: William MORATZ, Gardiner, NY (US)

(73) Assignee: SCHAEFFLER TECHNOLOGIES GMBH & CO. KG, Herzogenaurach (DE)

(21) Appl. No.: 14/218,193

(22) Filed: Mar. 18, 2014

Related U.S. Application Data
(60) Provisional application No. 61/815,069, filed on Apr. 23, 2013.

(51) Int. Cl. F16C 25/08

(52) U.S. Cl. CPC F16C 25/083
USPC 384/489; 384/517

(57) ABSTRACT

A preloaded rolling bearing assembly is provided. The rolling bearing assembly includes radially inner and outer bearing rings. The radially inner bearing ring includes a radially outer race, and the radially outer bearing ring includes a radially inner race, and a peripherally extending notch positioned at least on an axial end face of the radially outer bearing ring or the radially inner bearing ring. The rolling bearing assembly includes a plurality of rolling elements supported to roll on the radially outer race of the radially inner ring and the radially inner race of the radially outer ring. A preload element is positioned at least partially within the notch and extends past the axial end face of the radially outer bearing ring.

### INCORPORATION BY REFERENCE

The following documents are incorporated herein by reference as if fully set forth: U.S. Provisional Application No. 61/815,069, filed Apr. 23, 2013.

### FIELD OF INVENTION

This application is generally related to a rolling bearing and more particularly related to a preload element for a rolling bearing.

### BACKGROUND

Rolling bearings are widely used in various mechanical applications, including automotive and industrial applications. Preloading elements are used in rolling bearings to reduce vibrations and noise caused by radial or axial clearance between the rolling elements and the rings of the rolling bearing assembly.

Existing preloading elements include the use of separate coil springs positioned next to a bearing ring for exerting an axial force on the bearing ring to preload the rolling bearing. These coil springs increase the overall axial space of the rolling bearing assembly and can require twice the axial space of the nominal bearing size. Existing preloading elements may also require the faces of the bearing rings to be ground prior to installation, which adds to the time and cost associated with manufacturing the rolling bearing assembly.

### SUMMARY

It would be desirable to provide a compact, inexpensive, and interchangeable preload element for a rolling bearing assembly, and a rolling bearing assembly with such a preload element.

A preloaded rolling bearing assembly is provided. The preloaded rolling bearing assembly includes radially inner and outer bearing rings. The radially inner bearing ring includes a radially outer race, and the radially outer bearing ring includes a radially inner race. A peripherally extending notch is positioned at least on an axial end face of the radially outer bearing ring or the radially inner bearing ring. A plurality of rolling elements are supported to roll between the radially outer race of the radially inner ring and the radially inner race of the radially outer ring. A preload element is positioned at least partially within the notch and extends past the axial end face of the radially outer bearing ring or the radially inner bearing ring.

Preferred arrangements with one or more features of the invention are described below and in the claims.

### BRIEF DESCRIPTION OF THE DRAWINGS

The foregoing Summary as well as the following Detailed Description will be best understood when read in conjunction with the appended drawings. In the drawings:

FIG. 1 is a cross-sectional view of a first preferred embodiment of a rolling bearing assembly according to the invention.

FIG. 2 is a cross-sectional view of a second preferred embodiment of the rolling bearing assembly according to the invention.

FIG. 3 is a cross-sectional view of a third preferred embodiment of the rolling bearing assembly according to the invention.

FIG. 4 is a cross-sectional view of a preloaded duplex rolling bearing assembly.

FIG. 5 is a cross-sectional view of a fourth preferred embodiment of the rolling bearing assembly according to the invention.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “at least one of a, b, or c” (where a, b, and c represent the items being listed) means any single one of the items a, b, c or combinations thereof. The terminology includes the words specifically noted above, derivates thereof, and words of similar import.

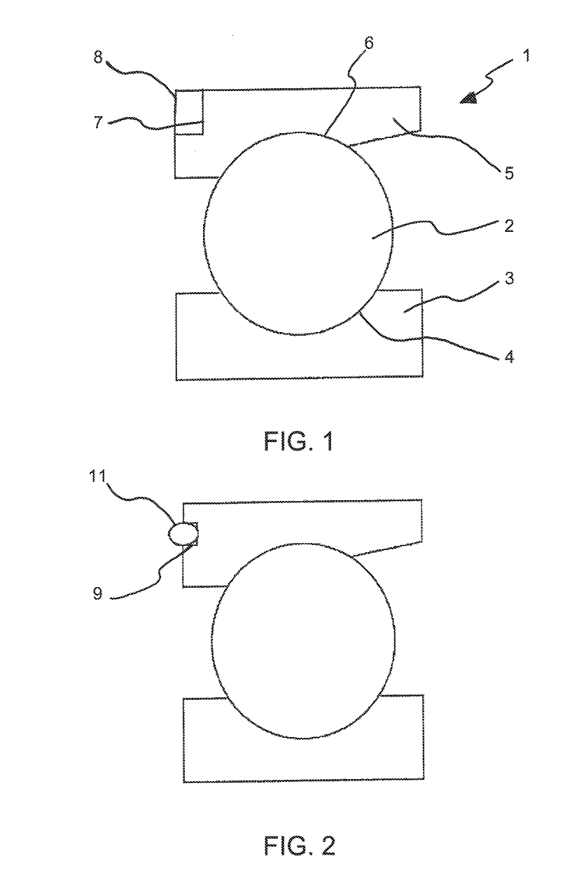

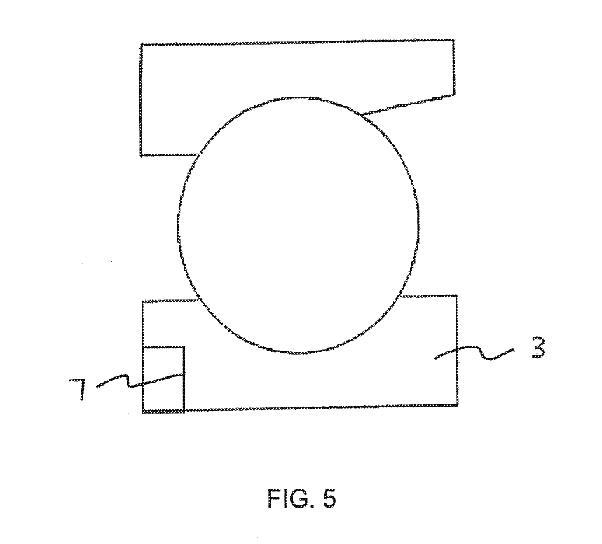

FIG. 1 shows a first preferred embodiment of a preloaded rolling bearing assembly 1 according to the present invention. The preloaded rolling bearing assembly 1 includes radially inner and outer bearing rings 3, 5. The radially inner bearing ring 3 includes a radially outer race 4, and the radially outer bearing ring 5 includes a radially inner race 6. Preferably, a notch 7 is positioned at least on an axial end face of the radially outer bearing ring 5. In another embodiment, shown in FIG. 5, the notch 7 is provided on the radially inner bearing ring 3, and the preload element is positioned at least partially within the notch 7 on the radially inner bearing ring 3. Preferably, the notch 7 extends in a peripheral direction. However, it would also be possible for the notch to include an arrangement of separate notches or pockets in the axial end face. The preloaded rolling bearing assembly 1 includes a plurality of rolling elements 2 supported to roll between the radially outer race 4 of the radially inner bearing ring 3 and the radially inner race 6 of the radially outer bearing ring 5.

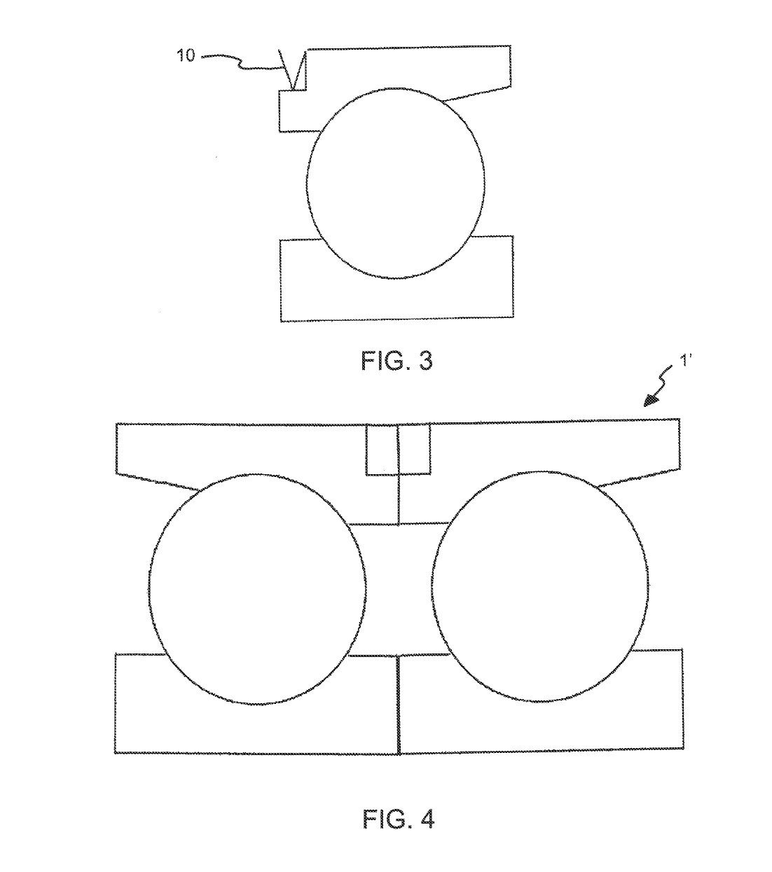

A preload element 8, 10, 11 is positioned at least partially within the notch 7 and extends past the axial end face of the radially outer bearing ring 5. The preload element 8, 10, 11 can engage a bearing housing or a bearing ring of another rolling bearing. As shown in FIG. 1, the notch 7 can be positioned at a radially outer corner of the radially outer bearing ring 5. Alternatively, as shown in FIG. 2, the notch 7 can be a groove in the axial end face of radially outer bearing ring 5. As shown in FIGS. 1-3, the preload element 8, 10, 11 can be an elastomer element 8, a lamellar or disc spring 10, an O-ring 11, or other suitably elastic body. The preload on the bearing ring can be adjusted by replacing the preload element with another preload element having a different stiffness. For example, the elastomer element 8 could be made of different durometer elastomeric materials to provide different preloads, or springs 10 with different spring constants could be used.

As shown in FIG. 4, in another embodiment of the invention a preloaded duplex rolling bearing assembly 1′ with an “O” arrangement is provided. In embodiments including angular contact rolling bearings, the notch 7 is provided on a preferably non-relieved end face of the bearing ring. In this embodiment, a preload element is provided for each radially outer bearing ring 5 and the preload elements press against each other. Although not illustrated in the drawings, alternate embodiments can include a single preload element for a duplex rolling bearing assembly. Additionally, a spacer can be provided between the bearings of the preloaded duplex rolling bearing assembly and each preload element can press against the spacer. Alternate embodiments may also include a preloaded duplex rolling bearing assembly with an “X” arrangement. In the “X” arrangement embodiment, the preload element for each bearing ring is provided on an axial end face of the bearing ring opposite from the adjacent bearing ring.

Having thus described various embodiments of the present preloaded rolling bearing assembly in detail, it will be appreciated and apparent to those skilled in the art that many changes, only a few of which are exemplified in the detailed description above, could be made in the bearing assembly according to the invention without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

### REFERENCE NUMBERS

1 Preloaded Rolling Bearing Assembly
1′ Preloaded Duplex Rolling Bearing Assembly
2 Rolling Element
3 Radially Inner Bearing Ring
4 Radially Outer Race
5 Radially Outer Bearing Ring
6 Radially Inner Race
7 Notch
8 Elastomer Element
9 Groove
10 Lamellar Spring
11 O-ring

What is claimed is:

1. A preloaded rolling bearing assembly, comprising:
radially inner and outer bearing rings, the radially inner bearing ring including a radially outer race, and the radially outer bearing ring including a radially inner race;
a notch positioned at least on an axial end face of the radially outer bearing ring or the radially inner bearing ring;
a plurality of rolling elements supported to roll between the radially inner race of the radially outer bearing ring and the radially outer race of the radially inner bearing ring; and
a preload element positioned at least partially within the notch that extends past the axial end face of the radially outer bearing ring or the radially inner bearing ring.

2. The preloaded rolling bearing assembly of claim 1, wherein the notch extends in a peripheral direction and is positioned at a radially outer corner of the radially outer bearing ring.

3. The preloaded rolling bearing assembly of claim 2, wherein the preload element is a lamellar spring.

4. The preloaded rolling bearing assembly of claim 2, wherein the preload element is a disc spring.

5. The preloaded rolling bearing assembly of claim 1, wherein the preload element is an elastomer element.

6. The preloaded rolling bearing assembly of claim 1, wherein the notch extends in a peripheral direction and the preload element is an O-ring.

7. The preloaded rolling bearing assembly of claim 1, wherein the notch is a groove in the axial end face of the radially outer bearing ring.

8. The preloaded rolling bearing assembly of claim 7, wherein the preload element is an O-ring located in the groove.
